(19) United States
(12) Patent Application Publication
(10) Pub. No.: US 2026/0068851 A1
(43) Pub. Date: Mar. 12, 2026

(54) PET CLEANING BRUSH

(71) Applicant: Dongguan Shengting Technology Co., LTD, Dongguan (CN)

(72) Inventor: Yipeng ZHANG, Dongguan (CN)

(73) Assignee: Dongguan Shengting Technology Co., LTD, Dongguan (CN)

(21) Appl. No.: 19/259,567

(22) Filed: Jul. 3, 2025

(30) Foreign Application Priority Data
Jul. 4, 2024 (CN) 202421568387.6

(51) Int. Cl. A01K 13/00; A46B 13/00; A46B 13/04; A46B 15/00

(52) U.S. Cl. CPC A01K 13/002; A01K 13/001; A46B 13/008; A46B 13/04; A46B 15/0016; A46B 2200/1093

(57) ABSTRACT

A pet cleaning brush is provided, relating to the technical field of pet supplies. The pet cleaning brush includes a housing, a rotating assembly and a liquid outlet assembly. The housing is provided with a container bottle and a brush head. A power supply is provided inside the housing, and the brush head is provided with a liquid outlet hole. The liquid outlet assembly includes a metering pump. The metering pump is arranged inside the housing and the metering pump is electrically connected to the power supply. The metering pump has an input tube extending into the container bottle and an output tube connected to the liquid outlet hole. The rotating assembly includes a motor. The motor is arranged inside the housing and is electrically connected to the power supply. The motor has an output shaft connected to the brush head.

### CROSS-REFERENCE TO RELATED APPLICATIONS

The application claims priority to Chinese patent application No. 202421568387.6, filed on Jul. 4, 2024, the entire contents of which are incorporated herein by reference.

### TECHNICAL FIELD

The present disclosure relates to the technical field of pet supplies, more particularly to a pet cleaning brush.

### BACKGROUND

With the development of social economy, people keep more and more pets and are more willing to take care of their pets, which has led to the emergence of many daily necessities for taking care of pets, such as cleaning brushes for bathing pets.

Existing pet cleaning methods usually employ a brush to manually brush the pet's hair. For example, a pet cleaning device with patent number 201020658653.6 includes a pet comb with bristles provided at a bottom thereof. Specifically, a water storage chamber is provided in the middle of the pet comb, and the water storage chamber is communicated with a water inlet at a top of the pet comb. A water outlet is formed at the bottom of the pet comb. After the cleaning device is filled with water, it is manually moved to help clean the pet, which has a single function.

### SUMMARY

The present disclosure provides a pet cleaning brush to solve the technical problem that existing pet cleaning brushes have a single function.

In order to solve the above technical problem, the present disclosure provides the following technical scheme.

A pet cleaning brush includes a housing, a rotating assembly and a liquid outlet assembly. The housing is provided with a container bottle and a brush head. A power supply is provided inside the housing, and the brush head is provided with a liquid outlet hole.

The liquid outlet assembly includes a metering pump. The metering pump is arranged inside the housing and the metering pump is electrically connected to the power supply. The metering pump has an input tube extending into the container bottle and an output tube connected to the liquid outlet hole.

The rotating assembly includes a motor. The motor is arranged inside the housing and is electrically connected to the power supply. The motor has an output shaft connected to the brush head.

Further, the liquid outlet assembly further includes a first circuit board and a liquid outlet button. The first circuit board is arranged inside the housing and is electrically connected to the power supply and the metering pump. The liquid outlet button is exposed out of a surface of the housing and is electrically connected to the first circuit board.

Further, the rotating assembly further includes a second circuit board and a rotation button. The second circuit board is arranged inside the housing and is electrically connected to the power supply and the motor. The rotation button is exposed out of the surface of the housing and is electrically connected to the second circuit board.

Further, the brush head includes a shell and a brush plate. The shell is moveably connected to the housing. The brush plate is arranged inside the shell, and the brush plate is covered with bristles. The shell is formed with through holes matched with the bristles, and the bristles pass through the through holes to extend out of the shell.

Further, the shell includes a bottom shell and a cover plate. The bottom shell is moveably connected to the housing. The cover plate is detachably connected to the bottom shell, and the through holes are arranged on the cover plate.

Further, the output shaft of the motor is connected to a drive shaft. The drive shaft is formed with a groove on a lateral surface of a tail end thereof. The cover plate is provided with a transmission rod. The transmission rod is formed with a transmission groove. The transmission groove is matched with the tail end of the drive shaft, and the tail end of the drive shaft is inserted into the transmission groove.

Further, the housing further has a connecting tube provided therein. The connecting tube is arranged inside the housing, and the connecting tube is formed with a shaft hole along an axial direction thereof. The bottom shell is sleeving on the connecting tube. Both the driving shaft and the transmission rod are inserted into the shaft hole and are connected inside the shaft hole.

Further, the housing has provided therein a fixing frame. The fixing frame is formed with a first fixing groove configured to fix an air pump and a second fixing groove configured to fix the first circuit board.

Further, the housing is provided with an internal thread on an inner wall of a bottom end thereof, and the container bottle is provided with an external thread at an opening thereof. The container bottle is connected to the housing through the mating of the external thread and the internal thread.

Further, the brush head further includes an ultrasonic board, and the ultrasonic board is arranged inside the shell.

The present disclosure has the following beneficial effects compared to the existing technology.

The pet cleaning brush provided by the present disclosure includes a housing, a rotating assembly and a liquid outlet assembly. The motor of the rotating assembly is configured to drive rotation of the brush head, whereby the brush head achieves a function of automatic brushing. Further, the slight vibration generated by the motor can provide a massaging function. The metering pump of the liquid outlet assembly is configured to pump a cleaning solution from inside the container bottle and eject it out from the brush head through the liquid outlet holes, which achieves the capability of intelligent control of delivery volume of cleaning solution. The pet cleaning brush provided by the present disclosure features automatic brushing, automatic delivery of liquid, intelligent control of volume and massaging function, which enables function diversity and is more convenient to clean pets.

### BRIEF DESCRIPTION OF DRAWINGS

FIG. 1 is a structure diagram of Embodiment 1 of the present disclosure.

FIG. 2 is a cross-sectional view of Embodiment 1 of the present disclosure.

FIG. 3 is an exploded view of Embodiment 1 of the present disclosure.

FIG. 4 is an exploded view of a brush head of Embodiment 1 of the present disclosure.

FIG. 5 is a structure diagram of Embodiment 2 of the present disclosure.

FIG. 6 is an exploded view of a brush head of Embodiment 2 of the present disclosure.

Reference numerals in the drawings are illustrated as below. 1, housing; 2, container bottle; 3, brush head; 4, liquid outlet hole; 5, metering pump; 6, motor; 7, first circuit board; 8, liquid outlet button; 9, second circuit board; 10, rotation button; 11, shell; 12, bristle; 13, through hole; 14, bottom shell; 15, cover plate; 16, drive shaft; 17, groove; 18, transmission rod; 19, transmission groove; 20, connecting tube; 21, shaft hole; 22, fixing frame; 23, first fixing groove; 24, second fixing groove; 25, brush plate; and 26, ultrasonic board.

### DETAILED DESCRIPTION OF THE EMBODIMENTS

The purpose, the technical scheme and the advantages of the embodiments of the present disclosure will become more clearly understood from the clear and complete description of the technical scheme of the embodiments of the present disclosure below taken in conjunction with the accompanying drawings in the present disclosure. Apparently, the embodiments described hereinafter are simply part embodiments of the present disclosure, rather than all of the embodiments. All other embodiments obtained by those ordinary skill in the art based on the embodiments of the present disclosure without creative work are intended to be included in the scope of protection of the present disclosure.

### Embodiment

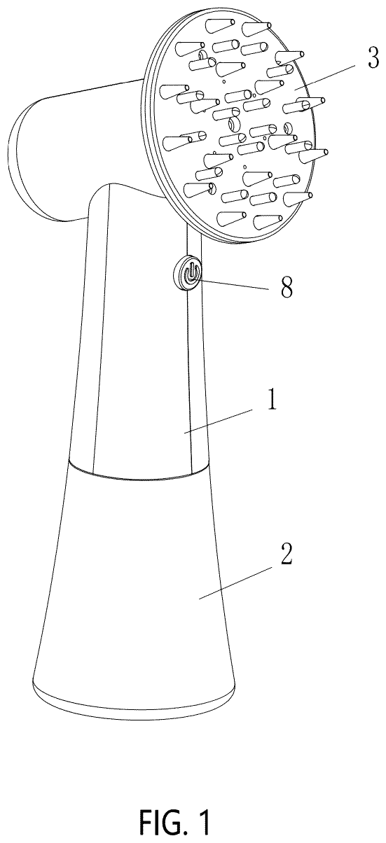

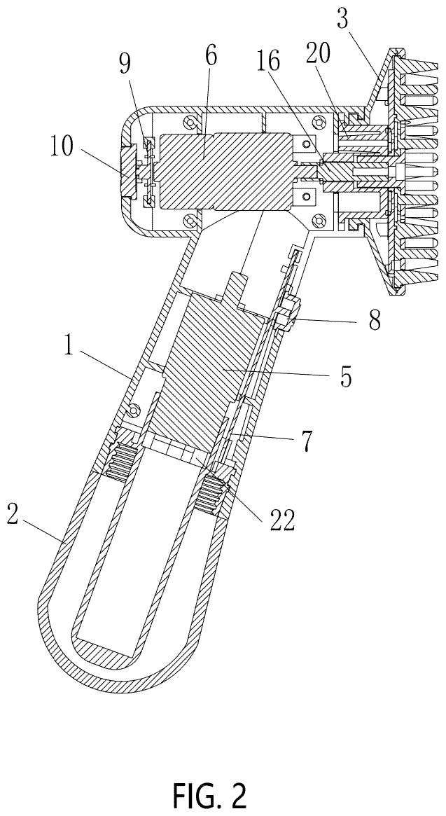

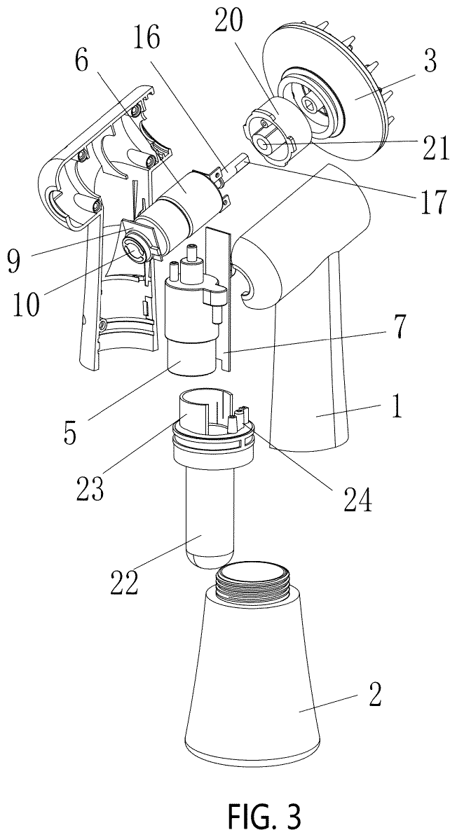

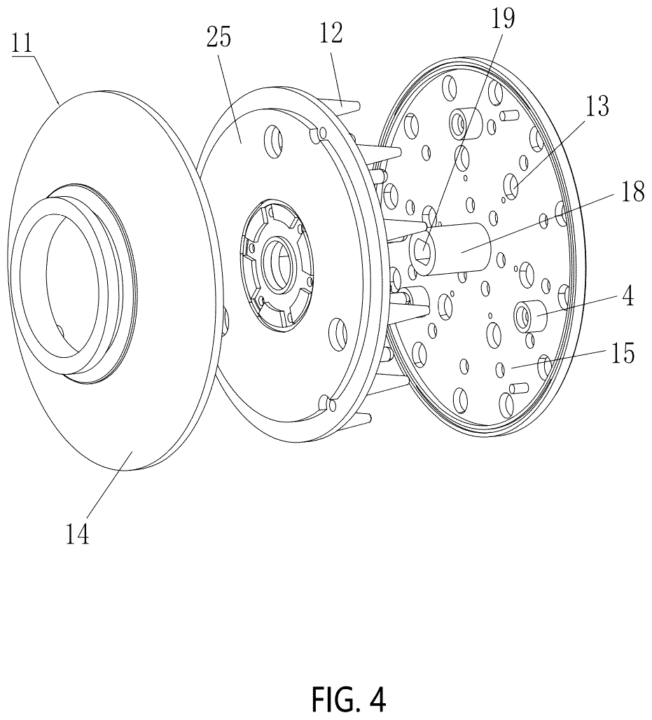

Referring to FIG. 1 to FIG. 4, a pet cleaning brush includes a housing 1, a rotating assembly and a liquid outlet assembly. The housing 1 is provided with a container bottle 2 and a brush head 3. The container bottle 2 is configured to hold a cleaning solution. A power supply is provided inside the housing 1. Herein, the power supply refers to a battery. The brush head 3 is provided with a liquid outlet hole 4. The liquid outlet assembly includes a metering pump 5. The metering pump 5 is arranged inside the housing 1 and the metering pump 5 is electrically connected to the power supply. The metering pump 5 has an input tube extending into the container bottle 2 and an output tube connected to the liquid outlet hole 4. The metering pump 5 is configured to pump the cleaning solution from inside the container bottle 2 and eject the cleaning solution out from the liquid outlet hole 4, which enables automatic delivery of liquid and intelligent control of volume. The rotating assembly includes a motor 6. The motor 6 is arranged inside the housing 1 and is electrically connected to the power supply. The motor 6 has an output shaft connected to the brush head 3. The motor 6 is configured to drive rotation of the brush head 3, thereby achieving a function of automatic brushing. Further, the slight vibration of the motor 6 can provide a massaging function, enabling more functions.

In the present embodiment, the liquid outlet assembly further includes a first circuit board 7 and a liquid outlet button 8. The first circuit board 7 is arranged inside the housing 1 and is electrically connected to the power supply and the metering pump 5. The liquid outlet button 8 is exposed out of a surface of the housing 1 and is electrically connected to the first circuit board 7. When the liquid outlet button 8 is pressed, the metering pump 5 pumps a fixed amount of cleaning solution to eject out from the liquid outlet hole 4.

In the present embodiment, the rotating assembly further includes a second circuit board 9 and a rotation button 10. The second circuit board 9 is arranged inside the housing 1 and is electrically connected to the power supply and the motor 6. The rotation button 10 is exposed out of the surface of the housing 1 and is electrically connected to the second circuit board 9. The rotation button 10 is configured to control the on and off of the motor 6.

In the present embodiment, the brush head 3 includes a shell 11 and a brush plate 25. The shell 11 is moveably connected to the housing 1. The brush plate 25 is arranged inside the shell 11, and the brush plate 25 is covered with bristles 12. The shell 11 is formed with through holes matched with the bristles 12. The bristles 12 pass through the through holes 13 to extend out of the shell 11.

In the present embodiment, the shell 11 includes a bottom shell 14 and a cover plate 15. The bottom shell 14 is moveably connected to the housing 1. The cover plate 15 is detachably connected to the bottom shell 14, and the through holes 13 are arranged on the cover plate 15.

In the present embodiment, the output shaft of the motor 6 is connected to a drive shaft 16. The drive shaft 16 is formed with a groove 17 on a lateral surface of a tail end thereof. The cover plate 15 is provided with a transmission rod 18. The transmission rod 18 is formed with a transmission groove 19. The transmission groove 19 is matched with the tail end of the drive shaft 16, and the tail end of the drive shaft 16 is inserted into the transmission groove 19. In particular, when the output shaft of the motor 6 is rotating, the drive shaft 16 rotates following the output shaft of the motor 6, and then the drive shaft 16 drives the transmission rod 18 to rotate as well, whereby causing rotation of the cover plate 15. Since the brush plate 25 is sleeving on the transmission rod 18, the brush plate 25 rotates following the cover plate 15. Since the shell 11 is connected to the cover plate 15, the shell 11 rotates following the cover plate 15 too, whereby the entire brush head 3 rotates following the drive shaft 16.

In the present embodiment, the housing 1 further has a connecting tube 20 provided therein. The connecting tube 20 is arranged inside the housing 1, and the connecting tube 20 is formed with a shaft hole 21 along an axial direction thereof. The bottom shell 14 is sleeving on the connecting tube 20. Both the driving shaft 16 and the transmission rod 18 are inserted into the shaft hole 21 and are connected inside the shaft hole 21. In addition, the driving shaft 16 is sleeved with a bearing. The driving shaft 16 is connected to the connecting tube 20 through the bearing, to avoid colliding with the connecting tube 20 when the driving shaft 16 is rotating.

In the present embodiment, the housing 1 has provided therein a fixing frame 22. The fixing frame 22 is formed with a first fixing groove 23 configured to fix an air pump and a second fixing groove 24 configured to fix the first circuit board 7.

In the present embodiment, the housing 1 is provided with an internal thread on an inner wall of a bottom end thereof. The container bottle 2 is provided with an external thread at an opening thereof. The container bottle 2 is connected to the housing 1 through the mating of the external thread and the internal thread, which eases the disassembly of the container bottle 2.

In addition, the housing 1 includes a left half body and a right half body. The left half body and the right half body are in detachable connection, specifically, in interference-fit snap connection.

### Embodiment

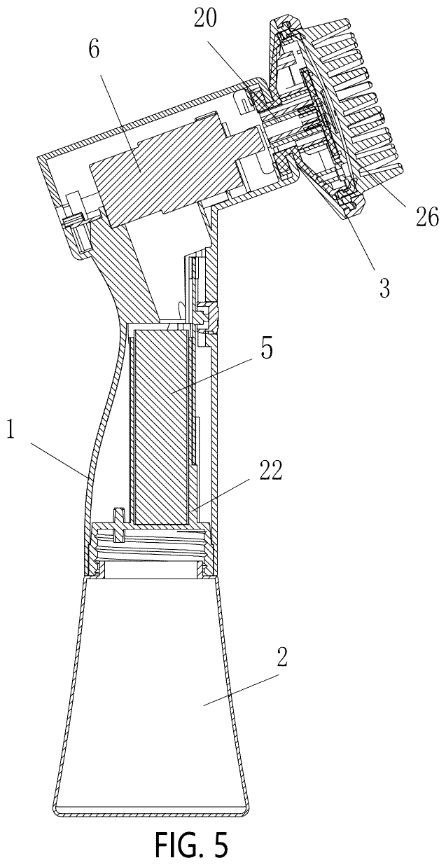

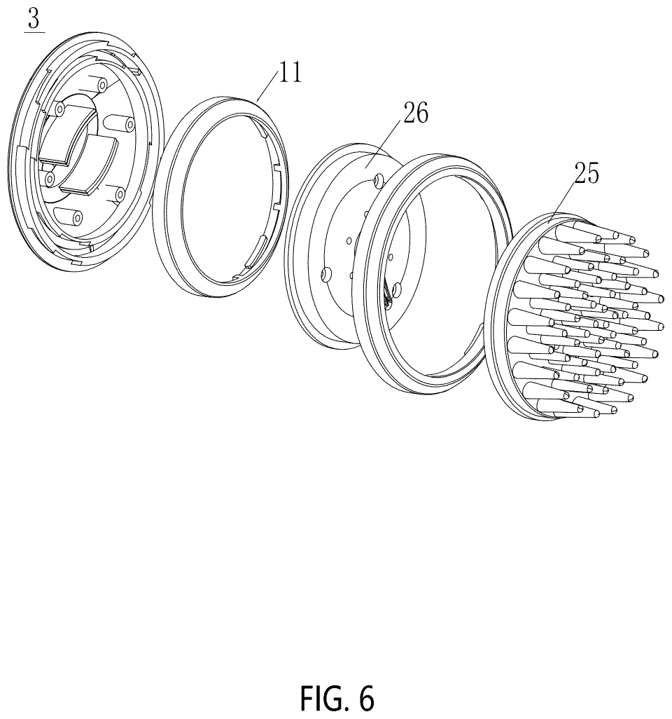

The present embodiment is another implementation scheme of the present disclosure. Referring to FIG. 5 and FIG. 6, this scheme is different from Embodiment 1 in that the brush head 3 further includes an ultrasonic board 26 and the ultrasonic board 26 is arranged inside the shell 11. The remaining structure is the same as in Embodiment 1.

In the present embodiment, the ultrasonic board 26 is configured to drive away bugs from the pet. The working principle of the ultrasonic board 26 is to drive away the bugs by imitating a frequency of a natural predator of the bugs.

### Embodiment

The present embodiment is another implementation scheme of the present disclosure. This scheme is different from Embodiment 1 in that: the pet cleaning brush is not provided with the motor 6, the second circuit board 9 and the rotation button 10, that is, the brush head 3 is not provided with a rotating function; and the brush head 3 further includes an ultrasonic board 26. The ultrasonic board 26 is arranged inside the shell 11 and is configured to drive away bugs from the pet.

The above are specific embodiments of the present disclosure merely, allowing those skilled in the art to understand or implement the present disclosure. Various modifications to these embodiments will be apparent to those skilled in the art, and the general principles defined herein can be implemented in other embodiments without departing from the spirit or scope of the present disclosure. Therefore, the present disclosure shall not be limited to the embodiments shown herein, but should conform to the widest scope consistent with the principles and novel features applied herein.

What is claimed is:

1. A pet cleaning brush, comprising a housing, a rotating assembly and a liquid outlet assembly, the housing being provided with a container bottle and a brush head, a power supply being provided inside the housing, and the brush head being provided with a liquid outlet hole;
the liquid outlet assembly comprising a metering pump, the metering pump being arranged inside the housing and the metering pump being electrically connected to the power supply, wherein the metering pump has an input tube extending into the container bottle and an output tube connected to the liquid outlet hole; and
the rotating assembly comprising a motor, the motor being arranged inside the housing and being electrically connected to the power supply, wherein the motor has an output shaft connected to the brush head.

2. The pet cleaning brush according to claim 1, wherein the liquid outlet assembly further comprises a first circuit board and a liquid outlet button, the first circuit board being arranged inside the housing and being electrically connected to the power supply and the metering pump, and the liquid outlet button being exposed out of a surface of the housing and being electrically connected to the first circuit board.

3. The pet cleaning brush according to claim 1, wherein the rotating assembly further comprises a second circuit board and a rotation button, the second circuit board being arranged inside the housing and being electrically connected to the power supply and the motor, and the rotation button being exposed out of the surface of the housing and being electrically connected to the second circuit board.

4. The pet cleaning brush according to claim 1, wherein the brush head comprises a shell and a brush plate, the shell being moveably connected to the housing, the brush plate being arranged inside the shell, and the brush plate being covered with bristles, wherein the shell is formed with through holes matched with the bristles, and wherein the bristles pass through the through holes to extend out of the shell.

5. The pet cleaning brush according to claim 4, wherein the shell comprises a bottom shell and a cover plate, the bottom shell being moveably connected to the housing, the cover plate being detachably connected to the bottom shell, and the through holes being arranged on the cover plate.

6. The pet cleaning brush according to claim 5, wherein the output shaft of the motor is connected to a drive shaft, the drive shaft being formed with a groove on a lateral surface of a tail end thereof; wherein the cover plate is provided with a transmission rod, the transmission rod being formed with a transmission groove, the transmission groove being matched with the tail end of the drive shaft, and the tail end of the drive shaft being inserted into the transmission groove.

7. The pet cleaning brush according to claim 6, wherein the housing further has a connecting tube provided therein, the connecting tube being arranged inside the housing, and the connecting tube being formed with a shaft hole along an axial direction thereof; wherein the bottom shell is sleeving on the connecting tube, both the driving shaft and the transmission rod being inserted into the shaft hole and being connected inside the shaft hole.

8. The pet cleaning brush according to claim 2, wherein the housing has provided therein a fixing frame, the fixing frame being formed with a first fixing groove configured to fix an air pump and a second fixing groove configured to fix the first circuit board.

9. The pet cleaning brush according to claim 1, wherein the housing is provided with an internal thread on an inner wall of a bottom end thereof, and wherein the container bottle is provided with an external thread at an opening thereof, the container bottle being connected to the housing through the mating of the external thread and the internal thread.

10. The pet cleaning brush according to claim 4, wherein the brush head further comprises an ultrasonic board, the ultrasonic board being arranged inside the shell.
